(19) United States
(12) Patent Application Publication
(10) Pub. No.: US 2006/0191172 A1
(43) Pub. Date: Aug. 31, 2006

(54) Display base

(76) Inventor: Matt Bays, Costa Mesa, CA (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 11/060,684

(22) Filed: Feb. 16, 2005

(51) Int. Cl. G09F 1/10

(52) U.S. Cl. 40/124

(57) ABSTRACT

A product display base for use with a product display tray. The display base includes a first, second, front and back vertical side. The sides define an interior hollow space that allows a base to be nested into another. A product display shelf and a support surface together define an L-shaped product support member that supports a product display tray. The base includes at least one set of wheels for transporting the base. A kit for displaying products includes a display base, a plurality of product display trays and means for attaching the product display tray to the display base. A method for displaying products includes providing a display base, providing a product display tray, coupling the display tray to the display base via fasteners, providing products, and coupling at least one removable graphic panel to the display base.

### BACKGROUND OF THE INVENTION

1. Field of the Invention

The invention relates to the field of displays. More particularly, the invention relates to a portable display base that is adapted to hold a product display tray.

2. Description of the Prior Art and Related Information

The distribution of products to retailers and the displaying of products in retail stores has become increasingly important in various industries. The conventional methods of displaying products involve the manufacturer having to supply both a display base and a product display tray that is positioned on the base. However, this conventional method presents several problems.

Primarily, conventional base units are not uniform between the manufacturers. The combination of many different base units in one retail store does not have a uniform appearance. Conventional displays cause aisles and counters to become a disarray of different display sizes, colors and materials. Also, the display bases might not have wheels. A display base without wheels presents multiple problems. For example, moving the display system in order to access items, re-stocking the shelves behind it or transferring the display system without causing damage becomes very difficult. Since the display systems can be very heavy and cumbersome the trays can get knocked off in transport, spilling all of their contents. Furthermore, many retail customers attempt to access items behind the displays, providing a liability to the retailer.

Another downfall to the conventional display systems and particularly in using a display base that does not include wheels is its shorter lifespan. A conventional base sits on the floor and is susceptible to the physical damage brought on by shopping carts and people kicking and bumping into it. Employees left with the task of moving a display without wheels is left with either disassembling the entire unit, or dragging, kicking and/or pulling it to the desired location.

Furthermore, conventional bases are composed of corrugated cardboard. This material becomes damp and weakened by a wet mop when the floor is cleaned. Without any space between the base and the floor, the mop may bump into the base while washing the floor around it and soak the base. Many display bases crumble under these wet conditions, spilling their contents onto the floor.

Conventional display bases are shipped in boxes and transported from the manufacturer to the retailer. In order to save on shipping space and freight charges, they are usually composed of many separate pieces that must be assembled. Alternatively, the bases are composed of one piece that must be folded into the desired assembled shape and connected at various points. Both of the above mentioned scenarios of shipping and assembling require assembly at the retail level, taking up valuable employee time and resulting in higher overhead costs.

The retail stores are forced to assemble mismatched displays that crowd their aisles. These poorly constructed displays provide no visual continuity to the store. Having a standardized base creates a uniform look and gives the retail store better control of their floor plan.

It is an object of the present invention to provide a display base that would standardize display footprints and structural base components. Said bases will be able to withstand strenuous conditions and offer a longer lifespan than conventional corrugated bases.

### BRIEF SUMMARY OF THE INVENTION

The present invention, in a preferred embodiment, is particularly, but not exclusively, useful as a standardized display base adapted to hold a product display tray. The novel design of the invention provides a standardized base that can withstand strenuous conditions and offers a longer lifespan than conventional bases. The invention provides a means for transporting the base and reduces shipping space and freight costs to the manufacturers. The invention further provides a display base that includes means for displaying advertising material.

In one aspect, a display base comprising a front and back and a first and second side, is provided. The display base is adapted to hold a product display tray. In a preferred embodiment, the base is unitary and L-shaped and comprises a hollow inner section. The hollow inner section enables the bases to be nested into one another for shipping purposes. The base includes a product display tray shelf adapted to support a product display tray that is stocked with merchandise. The base further includes a support surface. In a preferred embodiment the product display tray leans on the support surface and is coupled by fasteners thereto.

The base includes means for coupling graphics to the front, first and second sides thereof and thereby doubles as an advertising tool. In a preferred embodiment, the means for coupling the graphics include female slots along the peripheral of the front, back and first and second sides. Male inserts on the graphic panel are inserted into a corresponding female slot on the base. Also in a preferred embodiment, the male inserts are die-cut with the graphic panels.

In another aspect, the preferred means for coupling the graphics includes a transparent clear panel that includes male inserts. In this aspect, the graphic panels do not include male inserts and have flat edges. In a preferred embodiment, the clear panel can be placed over the graphic panel to protect it and expand its lifespan.

In another aspect, the front, back and first and second sides include contoured edges. These edges include female slots and provide a space for sliding in a flat clear panel. The clear panel is coupled to the edges via male inserts that correspond with the female slots on the edges. The clear panel, together with the space, forms a pocket insert. The pocket insert is adapted to hold graphic panels that are displayed through the clear panel. This aspect allows the user to easily slide the graphic panel into the pocket.

The base further includes a bottom portion that is capable of having permanent advertising printed on it. The bottom portion also acts as a stop for the bases when they are nested into one another.

Also, in a preferred embodiment, the base includes wheels for transporting the base and for keeping it off of the floor to increase its lifespan. The base includes a rear handle for transporting the base and for tipping the base on its wheels. Side handles are also provided in order to release the bases from one another. The back of the base may also include an aperture for accessing the hollow inner section.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a preferred embodiment of a display system according to the present invention.

FIG. 2 is an isometric view of a preferred embodiment of a display base according to one embodiment of the present invention.

FIG. 3 is an isometric view of a preferred embodiment of a product display tray shelf according to the present invention.

FIG.4 is an exploded view of a preferred embodiment of a display base having graphic panels according to the present invention.

FIG. 5 is a bottom view of preferred embodiment of a display base.

FIG. 6 is an isometric view of a preferred embodiment of a display base being adapted to be nested into one another according to the present invention.

FIG. 7 is a rear view of a preferred embodiment of a display base according to the present invention.

FIG. 8 is an exploded view of a second preferred embodiment according to the present invention.

FIG. 9 is an isometric view of a pocket for a third preferred embodiment for coupling graphics to the base according to the present invention.

FIG. 10 is an isometric view of the base for a third preferred embodiment for coupling graphics according to the present invention.

FIG. 11 is a preferred method for displaying products according to the present invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

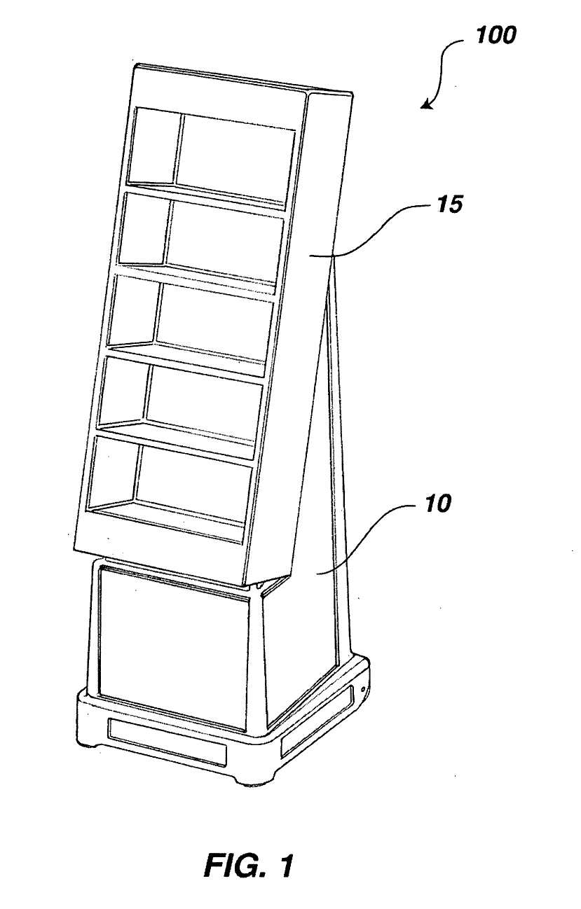

As seen in FIG. 1, a preferred embodiment of a display system referred to generally as 100 comprises a base 10 and a product display tray 15. The display system 100 of the present invention is adapted to be used in retail stores to advertise merchandise contained in the product display tray 15.

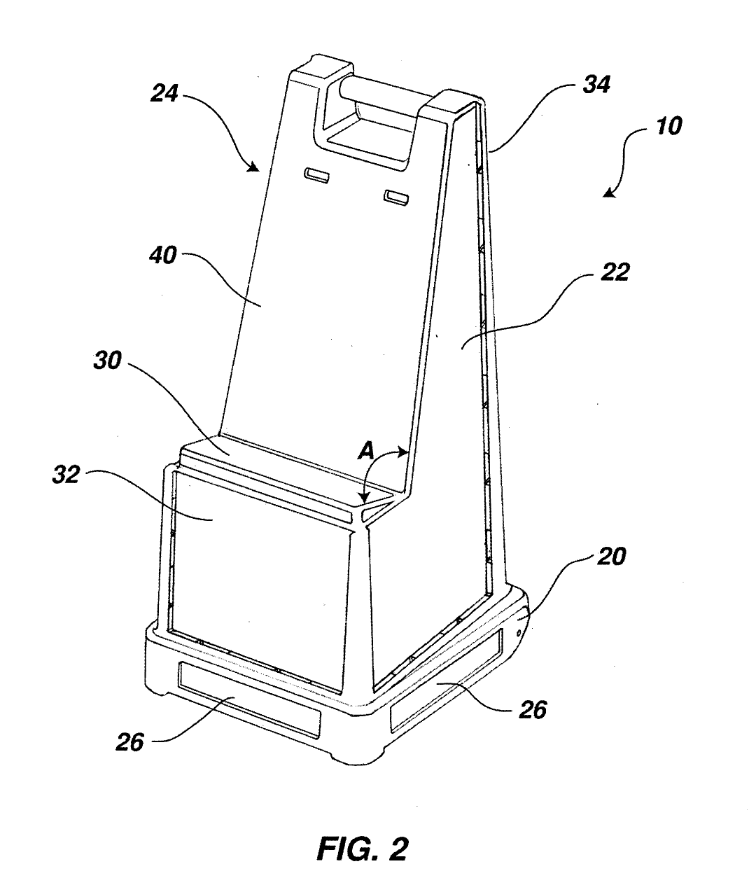

FIG. 2 illustrates a preferred embodiment of the base 10 comprising a bottom portion 20, and a first and second side 22, 24 being substantially vertical to the bottom portion 20. The base 10 further includes a support surface 40, a product display tray shelf 30, and a front and back side 32, 34. In the preferred embodiment, the front and back side 32, 34 are substantially vertical to the bottom portion 20. The support surface 40 and product display tray shelf 30, together define an L-shaped support member for the product display tray 15 (shown in FIG. 1). Unlike conventional display bases, the present invention is unitary wherein little to no assembly is required at the retailer end.

In the preferred embodiment, the support surface 40 is substantially vertical, but is angled at approximately 90 degrees with respect to the shelf 30, defined as A. Angle A biases the weight of the tray 15 toward the support surface 40 and prevents the product display tray 15 from tilting forward and falling off of the display system 100.

Also, in the preferred embodiment, the bottom portion 20 further comprises graphic space 26 for receiving store logos or other advertising messages and graphics. The graphics can be temporary or permanent, and can be produced using any graphic reproduction method, such as, but not limited to digital, mechanical, lithographic, screen printing, etc.

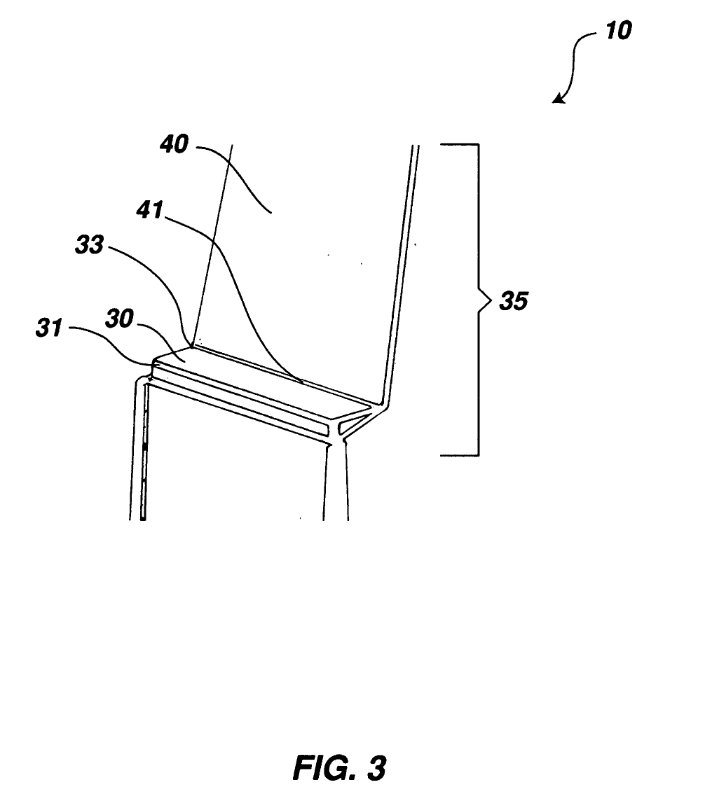

As best shown in FIG. 3, the product display tray shelf 30, has a front edge 31 and a back edge 33. The product display tray shelf 30 is substantially horizontal, but the front edge 31 is raised approximately 5-30 degrees up from a plane parallel to the floor upon which the unit 100 sits. The shelf 30 slopes downward from the front edge 31 to the back edge 33 adjacent to the support surface 40. The back edge 33 of the product display tray shelf 30 meets a bottom edge 41 of the support surface 40 to complete an L-shaped support member 35. The L-shaped support member 35 cradles the product display tray 15 (shown in FIG.1).

The preferred size of the display base is 14″wide×16″deep×36″ tall in order to meet retailer codes regarding displays. However, it is understood that the base 10 can be any size in order to meet retailer needs.

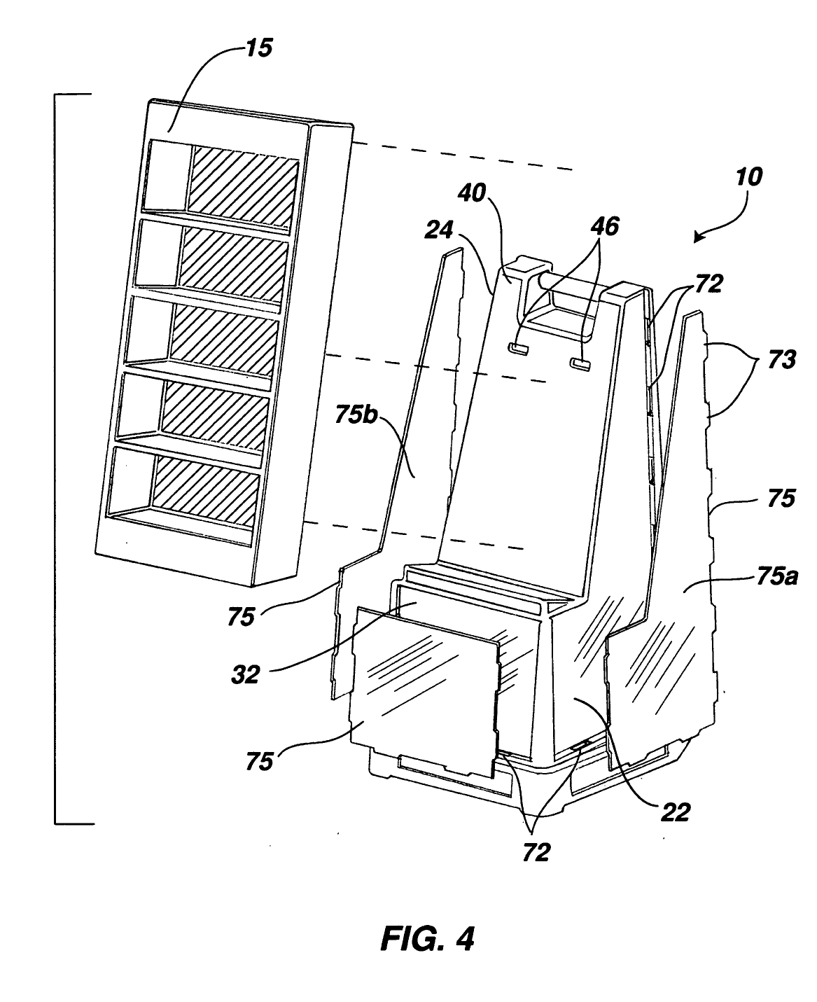

As illustrated in FIG. 4, the support surface 40 comprises at least one aperture, or slot, 46 adapted to receive a clip (not shown) so as to secure the tray 15 to the support surface 40, and thereby secure the tray 15 to the base 10. The aperture 46 is an attachment point for the product display tray 15 and the clip can comprise any attachment means such as a j-hook or s-fastener or any other fastening device. The fastening device can be primarily coupled to either the tray 15 or the support surface 40.

Unlike conventional bases, the present invention includes means for coupling various displays or advertisements to the sides thereof. If conventional bases include any graphic, it is a permanent graphic or advertisement affixed to the base itself usually for the manufacturer of the goods being carried. Conventional bases provide no means for alternating the graphics or presenting a standard look between the different manufacturers' displays.

However, in a preferred embodiment of the present invention, shown in FIG. 4, the base 10 further includes fastening means to couple graphic panels 75 to the base 10. The graphic panels 75 are releasably coupled to the base 10. The graphic panels 75 include a graphic side 75a that points away from the base 10, and an empty side 75b that lies against the base 10. It should also be understood that graphics could be included on both sides of the graphic panel 75 such that when the panel is flipped over it can be used in the other of the first or second side 22, 24.

Unlike conventional bases, graphic panels 75 allow the retailer to keep a uniform look throughout the store and have more advertising space within the store. The graphic panels 75 can be alternated and swapped out with either a standard look for the store or according to the product being displayed. The graphic panels 75 are preferably composed of paperboard, chip-board stock, Lexan, styrene, or sintra, but may also be composed of synthetic substrates.

In the preferred embodiment, shown best in FIG. 4, the base 10 includes female slots 72 around the peripheral of the first and second sides 22, 24 and the front side 32. The female slots 72 are adapted to receive male inserts 73 that are located on the peripheral edges of the graphic panels 75. In a preferred embodiment, the male inserts 73 are die-cut with the panels 75.

Each male insert 73 has a corresponding female slot 72 on the base 10 that it connects into. The male insert 73 to female slot 72 coupling allows for a tight connection between the graphic panel 75 and the base 10. To assemble the graphic panels 75 onto the base 10, the male inserts 73 are bent in the direction of the base 10 and inserted into the female slots 72.

In a preferred embodiment, the female slots 72 are evenly spaced along the peripheral edges of the front, first and second side 32, 22, 24 of the base 10 and the graphic panel 75. Once assembled, the graphic panel 75 lies flat against the base 10 without any protrusions from the graphic panel 75. It is understood that any fastening means can be used to couple the graphic panels 75 to the base 10 such as screws, adhesives, corner clips, hinged frames, j-tracks, etc.

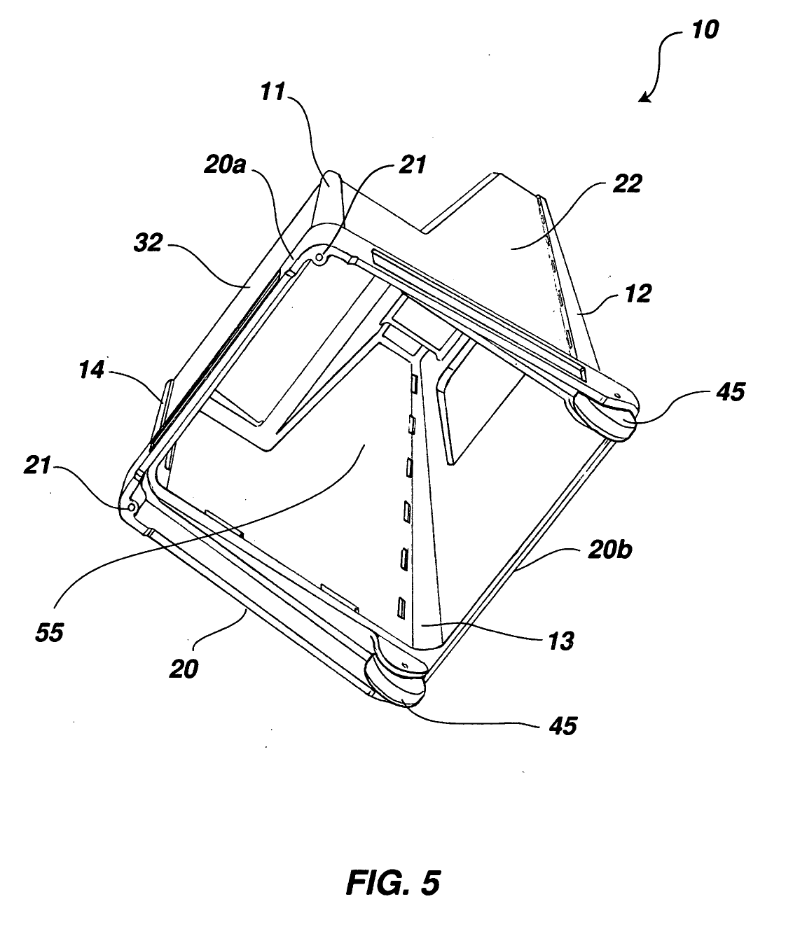

Best shown in FIG. 5, the base 10 comprises contoured edges 11, 12,13, 14 and defines an interior hollow space 55.

The bottom portion 20 is an oversized skirt and acts as a bumper for the base 10. The bottom portion 20 hides and protects a set of wheels 45 located on the back 20b of the bottom portion 20. The wheels 45 allow the base 10 to be easily transported. The front side 20a of the bottom portion 20 includes non-skid features 21 on the corners thereof. The non-skid features 21 temporarily bond the base 10 to the floor surface upon which it sits and provides resistance to the movement of the base 10. The non-skid features 21 also protect the floor surface from damage. In order to move the base 10 efficiently, the non-skid features 21 must be lifted off of the floor surface.

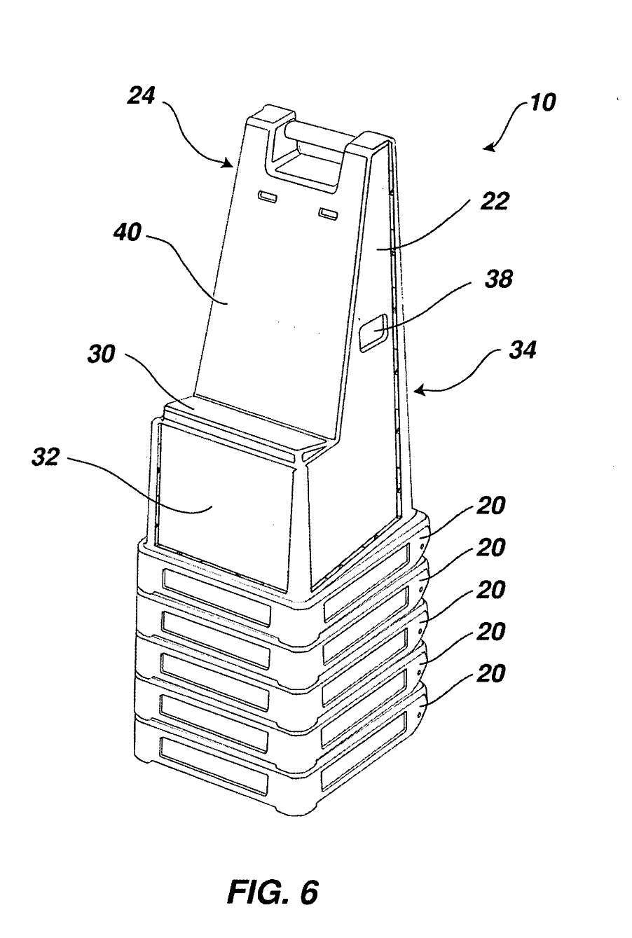

The hollow design minimizes the weight and shipping costs of the base 10, and as seen in FIG. 6, allows a base 10 to be nested within another base. In particular, the base 10 is configured to be nested within each other. In a preferred embodiment, the first and second sides 22, 24 and the front and back sides 32, 34 are tapered outward to make nesting of the bases 10 into one another possible. The bottom portion 20 acts as a stopper for the bases 10 as they are slid onto one another. In a preferred embodiment, the first and second sides 22, 24 comprise hand holes 38 that serve as handles for unnesting the bases 10 from each other.

In a preferred embodiment, the base 10 is composed of thermoformed plastic that may be injection molded. It is also understood that the base 10 can be comprised of any material, such as fiberglass, pigmented PVC or metal, that can withstand heavy wear and tear and is not susceptible to moisture. Unlike conventional bases, in the preferred embodiment, the base 10 requires minimal or no assembly and is received by the retailer in one ready to use piece. This design reduces assembly time and related overhead costs to the retailer. The current design also eliminates the need to separately ship bases that match every style of display tray.

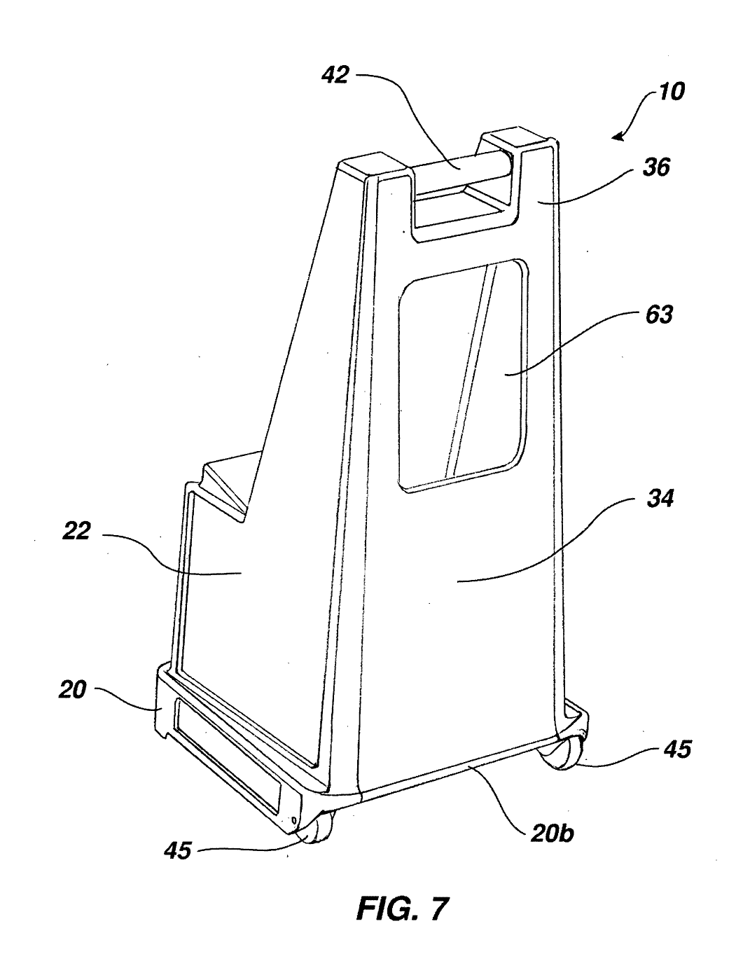

In the preferred embodiment, shown best in FIG. 7, the back edge 20b of the bottom portion 20 is contoured at an angle so that the base 10 can be tilted back and transported via the wheels 45. Although not necessary for operation, the wheels 45 can comprise locking casters to provide further stability when the base 10 is not being transported.

Also, in the preferred embodiment, the back side 34 of the base 10 includes a handle 42 for leveraging the base 10 on the wheels 45 and transporting it. The user can lean the top end 36 of the back side 34 towards the user with the handle 42 in order to move the base 10 around the store on the wheels 45. Therefore, the base 10 can be moved with or without a product display tray 15 coupled to it. The handle 42 can either be molded into the plastic base 10 or can be a standard handle 42 that is coupled to the base 10 after production.

In the preferred embodiment, the back side 34 further includes an aperture 63 that allows the user access to the interior of the base 10. The aperture 63 is also very useful in assuring that the fastening means or clips that couple the product display tray 15 to the base 10 are secure. Although not shown, shelving can be assembled within the base 10 in order to store additional merchandise.

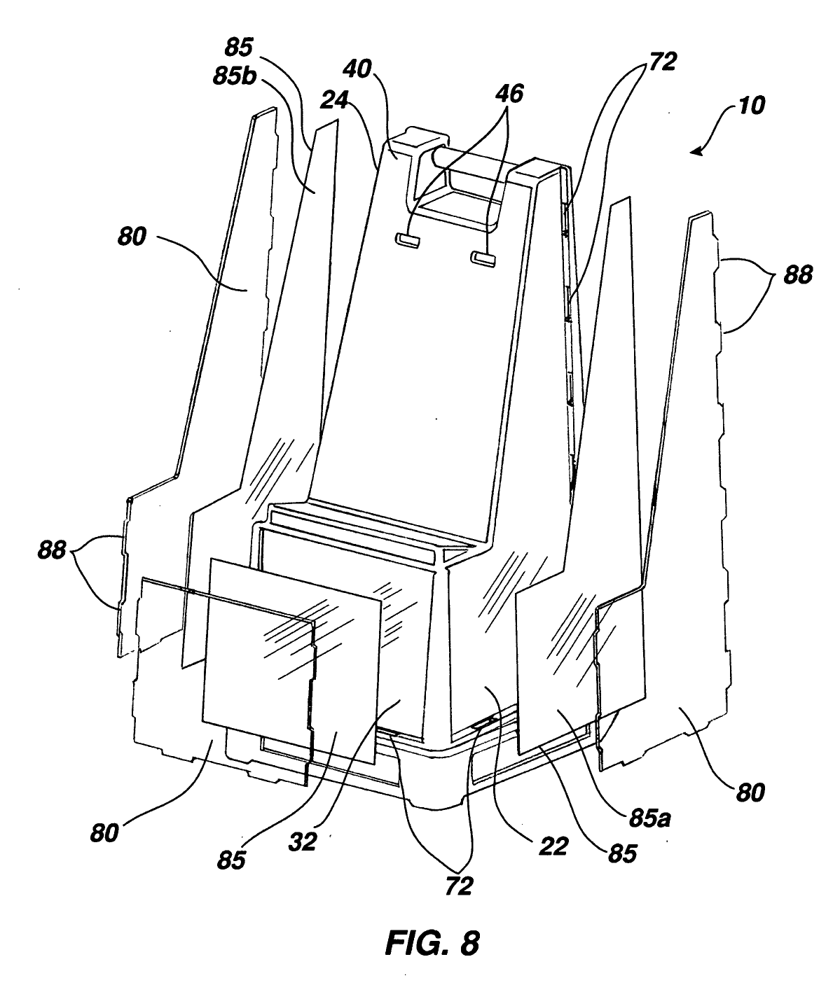

In a second preferred embodiment illustrated in FIG. 8, the base 10 can further include clear panels 80 that protect the graphic panels 85. The clear panels 80 include male inserts 88 on the peripheral edges thereof. The male inserts 88 are adapted to be inserted into female slots 72 located on the base 10. The male inserts 88 are preferably spaced an equal distance around the clear panels 80 in order to avoid bending or gaps in the graphic panel 85 or the clear panel 80.

The graphic panels 85 have a graphic design side 85a and an empty side 85b. To assemble the display base 10 so that the base 10 includes advertising or design graphics, graphic panels 85 are placed against the base 10 so that the graphic design side 85a is facing away from the base. The clear panels 80 are placed over the graphic panels 85 in order to protect the graphic panels 85 and expand their life term. The clear panels 80 can be composed of any transparent material, but are preferably composed of acrylic, clear Poly Vinyl Chloride (PVC), Poly Ethyl Teraphate Extrusion (PETE), Poly Ethyl Teraphate Glycol (PETG).

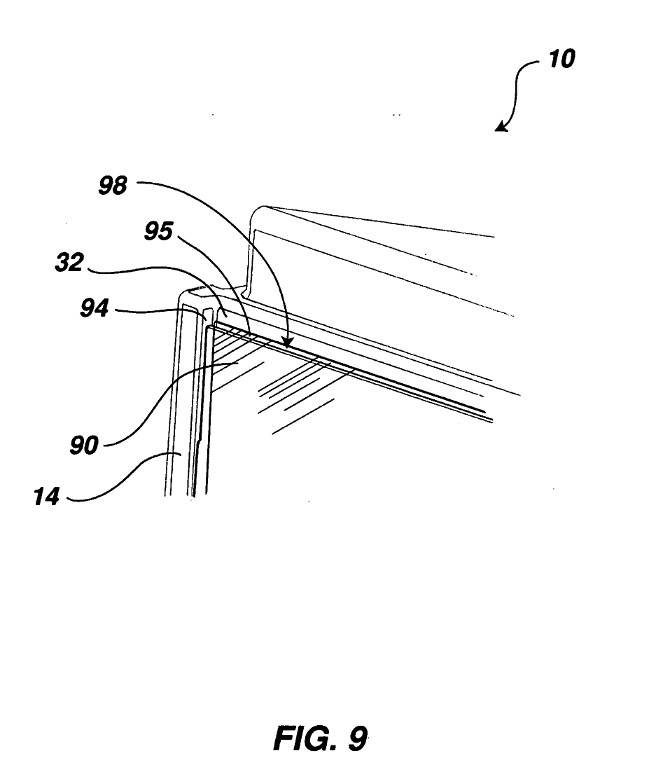

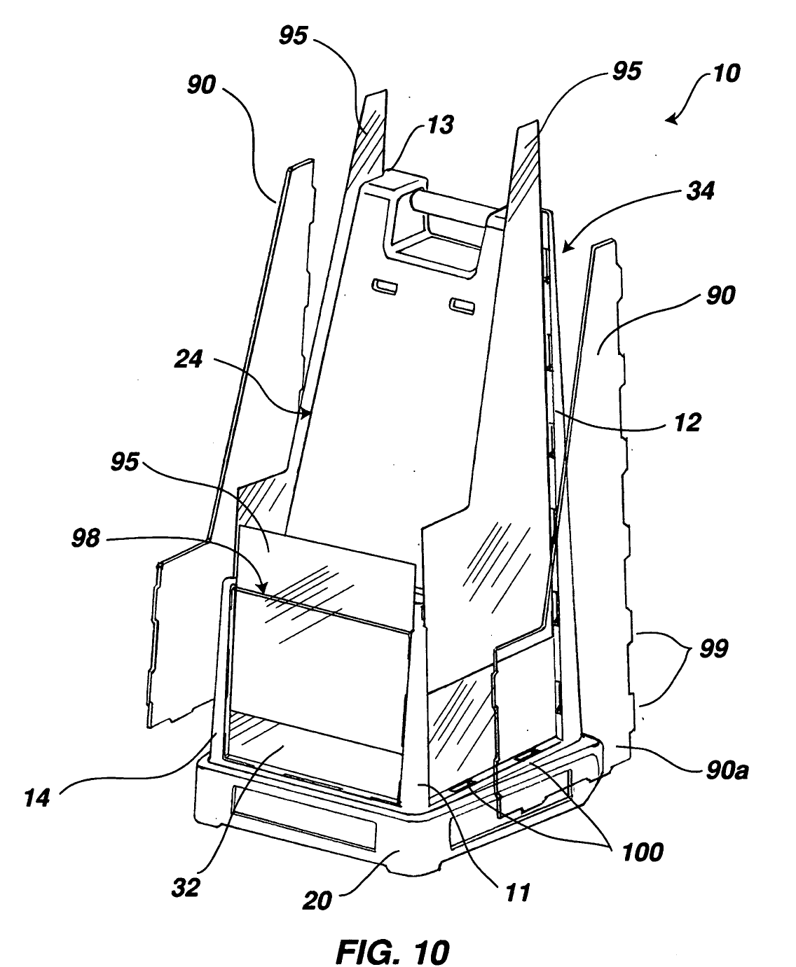

FIGS. 9 and 10 illustrate a third embodiment of the base 10, comprising a front, back, first and second side 32, 34, 22, 24 and a bottom portion 20. Each side 32, 34, 22, 24 includes contoured edges 11,12, 13,14. The contoured edges 11,12, 13,14 include a space 94 that allow a clear panel 90 to be coupled to the edges 11, 12,13, 14.

The clear panel 90 is slid into the grooves 94 of each contoured edge 11, 12, 13,14 and are coupled to the edges via male inserts 99. The clear panel 90, together with the space 94 of the edges 11, 12, 13,14 creates a pocket 98 on the front, and first and second side 32, 22, 24. The bottom 90a of each clear panel 90 includes male inserts 99 that correspond with female slots 100 located on the peripheral of each side 32, 22, 24 of the base. Once the clear panel 90 is coupled to the corresponding edges 11, 12, 13,14, a graphic panel 95 can be slid in behind the clear panel 90 and within the pocket 98. The graphic panel 95 is displayed through the clear panel 90.

A kit for displaying products is also provided by the present invention. The kit includes a reusable display base, a plurality of product display trays, and fastening means for coupling a product display tray to the display base. In the preferred embodiment, the display base is unitary and can be used with many different size product display trays. Also in the preferred embodiment, the fastening means can include, but is not limited to, clips, adhesives, snap-on, etc.

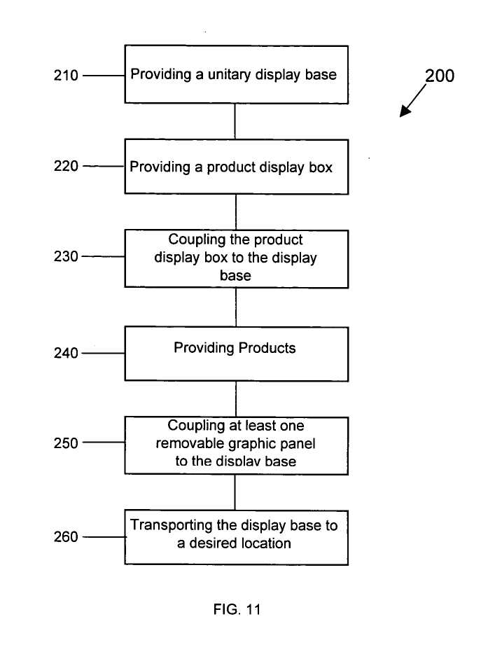

As shown in FIG. 11, a method 200 for displaying products is also provided. The method includes providing a unitary display base 210 and a product display tray 220. The product display tray can then be coupled to the product 230 display base via fasteners. Products are then provided 240 by the manufacturer and placed into the product display tray. Graphic panels can then be coupled to the display base 250, and then the display base can be transported to a desire location 260.

Many alterations and modifications may be made by those having ordinary skill in the art without departing from the spirit and scope of the invention. For example, it is also understood that the base 10 can be made of two or more pieces and nested within them selves for shipping. Once at the retailer, the pieces can be assembled and connected by fastening means to complete the base 10.

Furthermore, it should be understood that the base 10 can be molded to include tracks along the peripheral of the first and second sides 22, 24 and the front side 32 so that a graphic panel 75 can slide into the track and be held by it.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A display base for holding a product display tray, comprising:
a bottom portion;
a first vertical and second vertical side;
a product display tray shelf;
a front vertical side and a back vertical side,
a support surface;
wherein the first, second, front and back side form a hollow interior space.

2. The display base as in claim 1, wherein the base is unitary.

3. The display base as in claim 1, wherein the first, second, front and back side form contoured edges.

4. The display base as in claim 1, further comprising at least one set of wheels coupled to the bottom portion.

5. The display base as in claim 1, wherein the bottom portion comprises a bumper surface.

6. The display base as in claim 5, wherein the bottom portion further comprises space for coupling a graphic thereto.

7. The display base as in claim 1, wherein the first, second and front side include means for holding graphic panels.

8. The display base as in claim 7, wherein the graphic panels further comprise a plurality of male inserts along a periphery thereof.

9. The display base as in claim 7, wherein the first, second and front side further comprise apertures adapted to receive the male inserts of the graphic panels.

10. The display base as in claim 1, wherein the support surface and the product display tray shelf collectively form an L-shaped support member for the product display tray.

11. The display base as in claim 1, wherein the first and second side further comprise handles.

12. The display base as in claim 1, wherein the back side comprises a handle.

13. The display base as in claim 1, wherein the base is composed of thermoplastic.

14. The display base as in claim 13, wherein the base is composed of injection molded plastic.

15. The display base as in claim 1, wherein the base is composed of fiberglass.

16. The display base as in claim 1, wherein the base is composed of metal.

17. The display base as in claim 1, wherein the support surface lays at approximately 90 degrees to the shelf.

18. The display base as in claim 1, wherein the base is configured to be nested within another base.

19. The display base as in claim 1, wherein the base is a component of a display system.

20. The display base as in claim 1, wherein the support surface comprises at least one aperture adapted to receive a fastener from a product display tray.

21. The display base as in claim 1, wherein the support surface lays at approximately a right angle to a back edge of the display shelf.

22. A unitary display base for holding a product display tray, comprising:
a first and second side;
a bottom portion;
a front side and a back side;
a L-shaped product support member, the product support member comprising a support surface and a product display tray shelf; and
means for coupling graphics to the base.

23. The unitary display base of claim 22, wherein the front, first and second side define contoured edges.

24. The unitary display base of claim 23, wherein the contoured edges define space for receiving a protective structure.

25. The unitary display base of claim 24, wherein the contoured edges and the protective structure together define a pocket insert.

26. The unitary display base as in claim 22, wherein the base is adapted to be nested within another base.

27. The unitary display base as in claim 22, wherein the base is portable.

28. The unitary display base as in claim 22, wherein the support surface comprises at least one aperture adapted to receive a fastener from a product display tray.

29. The unitary display base as in claim 24, wherein the protective structure is a clear panel.

30. A display system, comprising:
a display base having a first and second vertical side, and a front and back vertical side; and
a product display tray.

31. The display system of claim 30, wherein the display base is unitary.

32. The display system of claim 30, wherein the product display tray is adapted to be coupled to the display base.

33. The display base system of claim 32, wherein the product display tray is coupled to the display base with a fastening means.

34. The display base system of claim 30, wherein the display base is adapted to receive removable graphic panels.

35. The display base system of claim 34, wherein the display base receives the removable graphic panels via fastening means.

36. The display base system of claim 34, wherein the display base comprises female slots located on the periphery of each of the first, second, and front sides.

37. The display base system of claim 35, wherein the display panels comprise male inserts on the periphery thereof that are adapted to insert into the female slots.

38. The display base system of claim 30, wherein the display base is reusable.

39. The display base system of claim 30, wherein the product display tray is adapted to hold retail products.

40. A method for displaying products, comprising:
providing a unitary display base;
providing a product display tray;
coupling the product display tray to the display base via fasteners;
providing products; and
coupling at least one removable graphic panel to the display base.

41. The method of displaying products of claim 40, further comprising:
filling the product display tray with desired products to be displayed.

42. The method of displaying products of claim 40, further comprising:
transporting the display base to a desired location via wheels.

43. A kit for displaying products, comprising;
a display base;
a plurality of product display trays; and
fastening means for coupling the product display tray to the display base.

44. The kit as in claim 43, wherein the product display trays are reusable.

45. The kit as in claim 43, wherein the display base is reusable.

46. The kit as in claim 43, further comprising:
a plurality of removable graphic panels adapted to be coupled to the display base.
